(19) United States
(12) Patent Application Publication
(10) Pub. No.: US 2013/0043857 A1
(43) Pub. Date: Feb. 21, 2013

(54) HYSTERETIC CHARGER FOR ENERGY HARVESTER DEVICES

(71) Applicants: Yogesh K. Ramadass, Dallas, TX (US); Brian P. Lum-Shue-Chan, Palm Bay, FL (US)

(72) Inventors: Yogesh K. Ramadass, Dallas, TX (US); Brian P. Lum-Shue-Chan, Palm Bay, FL (US)

(73) Assignee: Texas Instruments Incorporated, Dallas, TX (US)

(21) Appl. No.: 13/586,531

(22) Filed: Aug. 15, 2012

Related U.S. Application Data
(60) Provisional application No. 61/525,555, filed on Aug. 19, 2011.

(51) Int. Cl. G05F 3/02

(52) U.S. Cl. 323/311

(57) ABSTRACT

A hysteretic converter includes an inductor coupled between a source of voltage and a switch node. A low side switch is coupled between the switch node and a reference voltage. A high side switch is coupled between the switch node and the output of the converter. A driver controls the low side and high side switches, wherein the low side switch is turned on until the input current rises to a predetermined set point, the predetermined setpoint can be adapted to input current from the source of voltage.

### CROSS-REFERENCE TO RELATED APPLICATIONS

This patent application claims priority from U.S. Provisional Application No. 61/525,555 filed Aug. 19, 2011, which is incorporated herein by reference in its entirety. This application is related to U.S. patent application Ser. No. 13/XXX, XXX (TI docket number TI-70882), filed on even date herewith, and incorporated herein by reference in its entirety.

### FIELD OF THE INVENTION

The invention generally relates to a hysteretic charger, and more specifically, to a hysteretic converter suitable for a micro-power circuits operating from an energy harvester device.

### BACKGROUND OF THE INVENTION

The term “energy harvesting” has come to mean the obtaining of very small amounts of energy from the environment. The amount of energy involved may be measured in microwatts; for example, 1 μW. The energy harvesting devices can include solar cells, wind power devices, vibration powered piezoelectric devices, and thermoelectric devices, for example. The very small amount of power that is available, rules out power converters that have even micro-ampere standby currents.

The advent of ultra-low-power electronics has led to an increasing number of uses for such energy harvesting systems. For example, instead of utilizing cardboard signs to advertise the price of an item for sale in a store, an LCD display device can be utilized which receives such information via a radio signal. The device is powered by a small solar cell mounted within the display. The solar cell provides the necessary power to operate the LCD display without having to have it serviced by store personnel. Another use for micro power devices is in stress sensors for a highway bridge. The sensors can be applied to the bridge structure and powered by the vibrations of vehicles passing over the bridge so they can measure the stress forces within the bridge and report periodically to a central device. The control device can then alert people as to the status of the bridge, without the necessity of sending a crew to the bridge to make the measurements. Sensors utilized to determine the position of a valve in a high temperature plumbing system can be powered by a thermoelectric device utilizing the temperature differential across the pipes for power. This allows a wireless system to report on the status of the valve without requiring periodic replacement of a battery.

One of the challenges in producing a charger circuit for energy harvester device is that the charger input current can range from 1 μA this much is 100 mA, that is, over five orders of magnitude. Not only must the circuit maintain efficiency over this wide range of currents, it must have a quiescent current in a nanoampere range in order not to unnecessarily load the energy harvester device.

### SUMMARY OF THE INVENTION

It is a general object of the invention to provide a charger circuit for use with an energy harvester device.

In an aspect of the invention a hysteretic converter comprises an inductor coupled between a source of voltage and a switch node. A low side switch is coupled between the switch node and a reference voltage. A high side switch is coupled between the switch node and the output of the converter. A driver controls the low side and a high side switch, wherein the low side switch is turned on until the input current rises to a predetermined set point, the predetermined setpoint can be adapted to input current from the source of voltage.

Another aspect of the invention includes a method of harvesting energy. A hysteretic converter is coupled to an energy harvester device. A low side transistor of the hysteretic converter is turned on until input current reaches a predetermined set point. The predetermined set point is adapted to input current from the energy harvester device.

A third aspect of the invention includes a system for harvesting electrical energy from a micro-power energy harvesting device. A hysteretic voltage converter means regulates a voltage generated by the energy harvester device, the hysteretic voltage converter means including an inductance coupled between a source of voltage and a switch node. The hysteretic converter has a control circuit being formed on an integrated circuit having nanoampere standby current. The integrated circuit comprises a low side switch means coupled between the switch node and a reference voltage. A high side switch means is coupled between the switch node and an output of the converter. Driver means controls the low side and high side switch means, wherein the low side switch means is turned on until the input current rises to a predetermined set point, the predetermined set point can be adapted to input current from the source of voltage by being doubled after 3 consecutive current pulses at substantially the same set point.

### BRIEF DESCRIPTION OF DRAWINGS

Further aspects of the invention will appear from the appending claims and from the following detailed description given with reference to the appending drawings:

FIG. 1 is a schematic block diagram of a maximum power point tracking circuit connected to the charger circuit of the present invention; and

FIG. 2 illustrates the waveforms in the operation of the charger circuit shown in FIG. 1.

### DETAILED DESCRIPTION OF EXAMPLE EMBODIMENTS

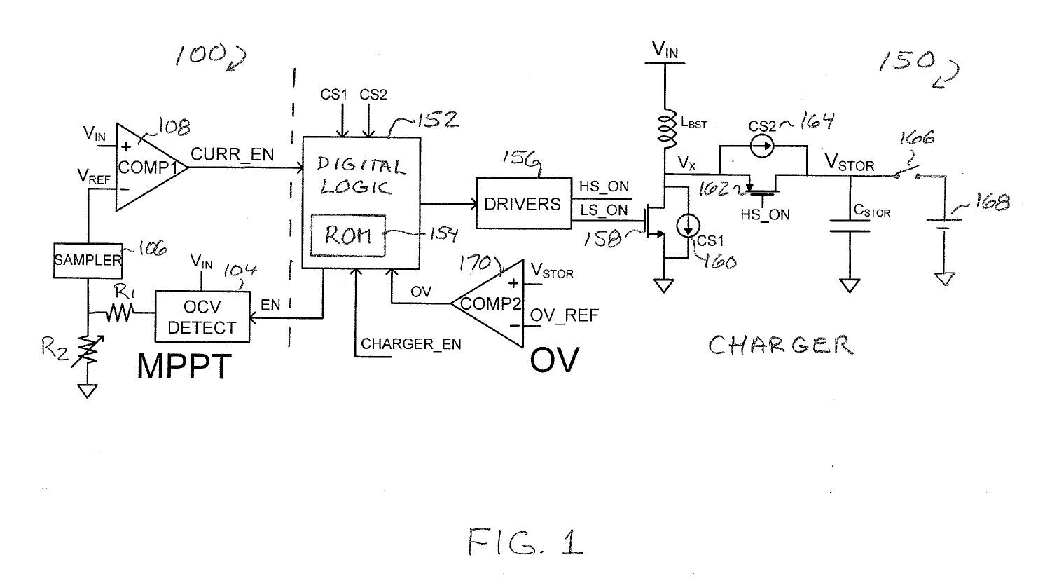

FIG. 1 shows a connection of a maximum power point tracking circuit shown generally as 100 with a charger circuit according to the present invention shown generally as 150. The elements of the maximum power point tracking circuit 100 are shown in detail and explained in co-pending application 13/XXX, XXX (TI 70882), filed on even date herewith and incorporated herein by reference in its entirety. A digital logic circuit shown as 152 in FIG. 1 is part of the maximum power point tracking circuit as well as being part of the charger circuit. In the portion related to the maximum power point tracking circuit 100, the digital logic circuit receives a signal CURR_EN from comparator 1,108. The signal CURR_EN controls the operation of the charger circuit 150 when the charger circuit is off, the digital logic circuit 152 provides a signal EN to activate the open circuit voltage detection circuit 104 which detects, using resistors R1, R2, a portion of the open circuit voltage of the energy harvester device. That sample is stored by sample and hold circuit 106 which applies it as a reference Vref to the inverting terminal comparator 1, 108. Input voltage Vin is applied to non-inverting terminal comparator 108. The digital logic circuit periodically samples the open circuit voltage of the energy harvester device in order to set the maximum power point at which the device should be operated for highest efficiency. In this maximum power point tracking circuit, a fraction of the open circuit voltage is utilized as the maximum power point for the energy harvesting device. When the input voltage exceeds the predetermined fraction of the input voltage that is utilized as the maximum power point, the signal CURR_EN is generated by comparator 1,108 which tells the digital logic circuit to operate the charger. When the input voltage falls below the maximum power point, comparator 1,108 de-asserts the signal CURR_EN and the charger is turned off. The charger is also turned off periodically and the fraction stored in sample hold circuit 106. The digital logic circuit can utilize data stored in the read-only memory 154, which can be a ROM, EE PROM or similar memory, to choose the time between samples and a sample time. The digital logic will turn off the drivers 156 for the charger circuit so that the open circuit voltage can be detected. A sample time of 256 milliseconds with a sample interval of 16 seconds can be utilized, for example.

Accordingly, the charger circuit must maintain stability when turned off asynchronously to maintain the maximum power point operation for the energy harvester device and when turned off and turned back on periodically to measure the open circuit voltage of the energy harvester device. Another requirement for the charger circuit 150 is to handle current outputs from the energy harvester device ranging from 1 μA to 100 mA, that is, over five orders of magnitude, so that it can operate with a wide variety of energy harvester devices. In order to avoid unnecessarily loading the energy harvesting device, the quiescent current drawn by the charger must be kept within the nanoampere range, for example less than 200 nanoamperes.

The charger circuit 150 comprises the digital logic circuit 152 with its read-only memory 154 which has an output signal to a driving circuit 156. Driving circuit 156 generates a signal LS_ON to drive a low side transistor switch 158 and a signal HS_ON and to drive a high side transistor switch 162. The low side switch 158 is an NMOS transistor having a source connected to ground and a drain connected to a switch node Vx. An inductor Lbst is connected between the input voltage from the energy harvester, Vin, and the switch node Vx. The high side switch 162 is a PMOS transistor having its source connected to the switch node of Vx and its drain connected to the positive terminal of a storage capacitor Cstor. A current sensor CS1, 160 is connected to transistor 158 and a current sensor CS2, 164 is connected to transistor 162. The outputs of the current sensors are applied to the digital logic circuit 152. A capacitor Cstor is disconnected from the drain of transistor 162 to ground. Optional battery 168 is connected, via switch 166, to the positive terminal capacitor Cstor and to ground. An overvoltage circuit comprises comparator COMP2, 170 which has output signal OV connected to the digital logic circuit 152 has its noninverting terminal of comparator 170 connected to the voltage Vstor on capacitor Cstor and its inverting input connected to a reference voltage OV_REF.

When enabled by the current enable signal CURR_EN, the digital logic circuit 152 enables the drivers 156 to generate signals LS_ON and HS_ON which are connected to both the low side transistor 158 and high side transistor 162, respectively. Transistor 162 is off when transistor 158 is on and vice versa. The current through transistor 160 is measured by sensors CS1, 160 and a current through transistor 162 is measured by sensors CS2, 164. Transistor 158 is turned on by signal LS_ON until the current through transistor rises to a predetermined set point ISET. The value for currents that point ISET can be chosen by a two bit digital signal, for example. The values can be chosen as 25 mA, 50 mA, 100 mA or 200 mA, for example. Once current sensors CS1 detects that the current has crossed the set point, the signal LS_ON goes low return to off transistor 158 and the signal HS_ON and goes high to turn on transistor 162. This signal HS_O and remains high until the current through transistor 162 hits zero which is detected by current sensor CS2, 164. The process then repeats.

At this point, if this signal CURR_EN is still high, another current pulse starts. Once 3 current pulses are generated at the same set point ISET, the value ISET is incremented and the process repeats. For example, after three identical pulses, ISET will be doubled. If, on the other hand, the current enable signal CURR_EN is de-asserted at the end of the current pulse, the value of ISET is reduced, which is utilized by the charger when it restarts. The value ISET can be halved, for example.

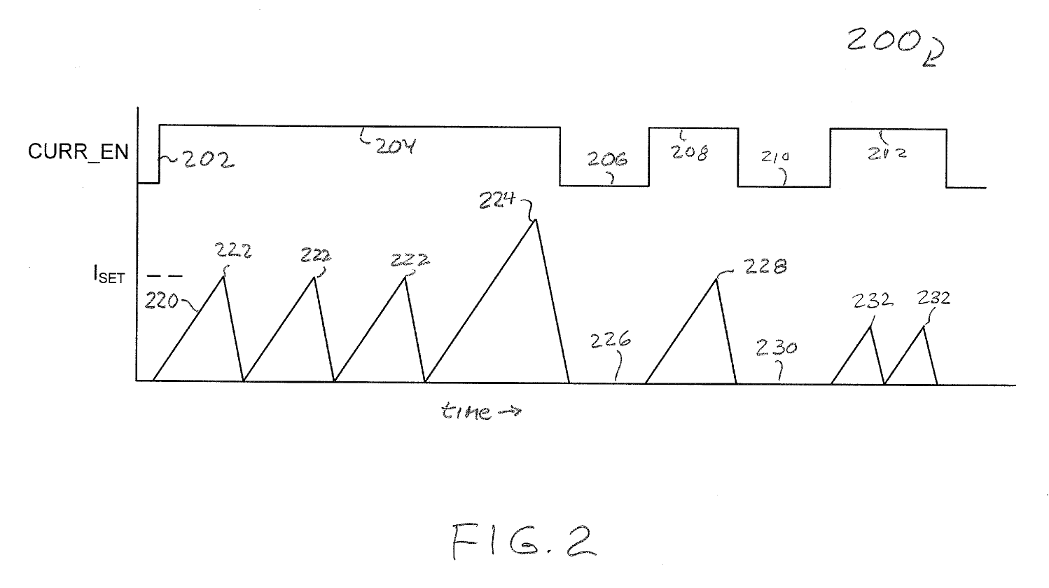

This operation can be seen in connection with the waveform shown in FIG. 2, for example. In FIG. 2, 202 is the current enable signal CURR_EN output from digital logic circuit 152. The waveform 220 is the current through the inductor Lbst. When transistor 158 is turned on, the current through inductor Lbst 220 increases linearly until it reaches the set point 222 at which time transistor 158 is turned off and transistor 162 is turned on. Transistor 162 stays on until the current through inductor Lbst drops to zero. The current through transistor 158 is measured by current sensor CS1, 160 and a current through transistor 164 is measured by current sensor CS2, 164. The process repeats if the current enable signal CURR_EN remains high. If, as illustrated in FIG. 2, 3 consecutive pulses reach the same set point 222, the set point is doubled to 224 for the next pulse. If, as illustrated at 206, the current enable signal CURR_EN goes low, there is no pulse generated as illustrated at 226. When the current enable signal CURR_EN goes high again, as illustrated at 208, a reduced set point 228 is used. For example, set point 228 maybe half that of set point 224. If the current enable signal CURR_EN 202 goes to zero again, as illustrated at 210, no current pulse be produced as shown at 230. When the charger restarts as shown at 212, the current set point will be reduced again to 232.

An overvoltage circuit comprises comparator 2, 170, which receives at its noninverting input the output of storage capacitor Cstor and an overvoltage reference at its inverting input. When the voltage across the capacitor Cstor rises above the overvoltage reference, a signal OV input to the digital logic turns off the charger to avoid overcharging the capacitor. If it is desired to charge a battery 168, the switch 166 can be closed once the voltage on the capacitor Cstor rises to the appropriate level to charge the battery. The charger may also be controlled by an external signal CHARGER_EN from other circuits in a battery management circuit (not shown) which may monitor battery temperature, for example.

It should be noted that the conduction losses for this type of charger are related to the square of the peak current times the Rds of the transistors 158, 162 divided by three. Thus, by reducing the peak current, the efficiency of the charger is dramatically improved. In this situation, in which very small amount of power may be involved, this is a significant advantage. Furthermore, the charger does not require a clock, which is a significant user of current, so that the circuit can be designed to draw less than 200 nanoampere, for example. The circuit is also stable despite being turned on and off to maintain the operating point of the energy harvester at its maximum power point or to allow for the periodic measurement of the open circuit voltage.

Although the invention has been described in detail, it should be understood that various changes, substitutions and alterations can be made thereto without departing from the spirit and scope of the invention as defined by the appended claims.

1. A hysteretic converter comprising:
an inductor coupled between a source of voltage and a switch node;
a low side switch coupled between the switch node and a reference voltage;
a high side switch coupled between the switch node and the output of the converter;
a driver for controlling the low side and high side switches, wherein the low side switch is turned on until the input current rises to a predetermined set point, the predetermined setpoint can be adapted to input current from the source of voltage.

2. The hysteretic converter of claim 1 wherein the predetermined set point is increased after a predetermined number of consecutive current pulses at the same set point.

3. The hysteretic converter of claim 2 wherein the predetermined set point is doubled in value after 3 consecutive current pulses at the same set point.

4. The hysteretic converter of claim 1 wherein if the converter is turned off, the predetermined set point is reduced when the converter restarts.

5. The hysteretic converter of claim 4 wherein this set point is halved.

6. The hysteretic converter of claim 1 wherein the converter is coupled between an energy harvester device and the load, operation of the hysteretic converter being controlled by a maximum power point tracking circuit for the energy harvester.

7. The hysteretic converter of claim 4 wherein the converter is coupled between an energy harvester device and a load, operation of the hysteretic converter being controlled by a maximum power point tracking circuit for the energy harvester, the converter being turned off when output of the energy harvester device falls below the maximum power point.

8. The hysteretic converter of claim 7 wherein the energy harvester device is one of the groups consisting of a solar cell, a thermoelectric generator, a piezoelectric device, a radio frequency receiver and a wind driven generator.

9. The hysteretic converter of claim 8 wherein power is supplied to a battery or a super capacitor coupled to an output of the voltage regulator

10. A method of harvesting energy comprising:
coupling a hysteretic converter to an energy harvester device;
turning on a low side transistor of the hysteretic converter until input current reaches a predetermined set point;
adapting the predetermined set point to input current from the energy harvester device.

11. The method of claim 10 comprising increasing the predetermined set point after a predetermined number of consecutive current pulses at the same set point.

12. The method of claim 11 wherein the predetermined set point is doubled after 3 consecutive current pulses at the same set point.

13. The method of claim 10 comprising turning off the hysteretic converter periodically;
reducing the predetermined set point for use when the hysteretic converter restarts.

14. The method of claim 13 wherein the set point is halved.

15. The method of claim 13 wherein the hysteretic converter is periodically turned off by a maximum power point tracking circuit for the energy harvester.

16. A system for harvesting electrical energy from a micro-power energy harvesting device comprising:
hysteretic voltage converter means for regulating a voltage generated by the energy harvester device, the hysteretic converter means including an inductance coupled between a source of voltage and a switch node;
the hysteretic voltage converter means having a control circuit being formed on an integrated circuit having nanoampere standby current comprising:
low side switch means coupled between the switch node and a reference voltage;
high side switch means coupled between the switch node and an output of the converter;
driver means for controlling the low side and high side switch means, wherein the low side switch means is turned on until the input current rises to a predetermined set point, the predetermined set point being adapted to input current from the source of voltage by being doubled after 3 consecutive current pulses at substantially the same set point.

17. The hysteretic converter of claim 16 wherein if the converter is turned off, the predetermined setpoint is reduced when the converter restarts.

18. The hysteretic converter of claim 17 wherein the set point is halved.

19. The hysteretic converter of claim 16 wherein the converter means is coupled between an energy harvester device and a load, operation of the hysteretic converter means being controlled by a maximum power point tracking circuit means for the energy harvester device.

20. The hysteretic converter of claim 19 wherein the energy harvester device is one of the groups consisting of a solar cell, a thermoelectric generator, a piezoelectric device, a radio frequency receiver and a wind driven generator.
